(19) United States
(12) Patent Application Publication
(10) Pub. No.: US 2018/0366157 A1
(43) Pub. Date: Dec. 20, 2018

(54) VIDEO STORAGE

(71) Applicant: 7TH SENSE DESIGN LIMITED, Sussex (GB)

(72) Inventors: Richard BROWN, Sussex (GB); Richard NEALE, Sussex (GB); Ian MACPHERSON, Sussex (GB)

(21) Appl. No.: 16/061,270

(22) PCT Filed: Dec. 9, 2016
(86) PCT No.: PCT/GB2016/053885

§ 371 Date: Jun. 11, 2018

(30) Foreign Application Priority Data
Dec. 9, 2015 (GB) 1521675.7

(51) Int. Cl. G11B 20/10; G11B 20/18

(52) U.S. Cl. CPC G11B 20/10527; G11B 20/1889; G11B 2220/415; G11B 2020/1896; G11B 2020/10537

(57) ABSTRACT

A video storage apparatus is described which stores and provides access to a video sequence of images. The apparatus comprises an array of storage devices, each image in the sequence being stored on at least one of the storage devices in the array, or being distributed across the array of storage devices with each portion being independently reproducible. A driver is provided, the driver being operable to access the video sequence by reading images in time order from the array of storage devices, temporally adjacent ones of the images, or different portions of the same image, being read by the driver from different storage devices in the array. In this way, an array of independent drives can be used to store video and allow much faster access to the stored video than would be the case with a single drive, and in a way which is more robust to drive failure.

The present invention relates to an apparatus and method of storing video.

For some applications, very high resolution video sequences may need to be stored in uncompressed form to preserve quality. Where such video sequences have a high frame rate (for example 60 frames per second), it may not be possible to read the video sequence from a single storage device fast enough for real time playback. To address this problem, such a video sequence may be stored using a RAID (redundant array of inexpensive disks) configuration to enable smooth running of image sequence media (which is important to the viewer's immersion and overall experience), stored in sets of individual files, at high resolutions and frame rates. In this way media files can be played at up to 120 Hz or higher to meet display system requirements. One business use of such a media server is theme park rides, since a benefit of running at high frame rates when watching video whilst in motion is a reduction of motion sickness. Another use might be next generation cinema where framerates are moving to 60 Hz or 120 Hz. A further use may be after action review of flight simulation from image generator (IG) video capture.

Under RAID, a playback system may use several SSDs (solid state drives) to be ‘ganged together’ (this is referred to as ‘striped’ in standard RAID terminology) to create a single logical drive (RAID) on a computer. This setup allows the data to be split equally between the disks. By splitting media across disks the bandwidth of data from the logical drive is increased in proportion to the number of drives in the set. For example, with an 8 disk RAID setup providing a 2 TB server: Single Logical Drive [E:\] (HBA/RAID) which uses 8× 250 GB-SSDs. RAID0 gives no data redundancy and the data is split equally between the 8 SSDs: each of the 8 disks stores ⅛th of each image frame.

It will therefore be appreciated that by ganging the disks in this way, it is possible to playback extremely large resolution media at high framerates. However, occasional failures may occur. These could be due to a single disk failure or may be due to hardware or software issues between computer/HBA (Host Bus Adapter) or RAID adapter/SSDs. In any case, a single failure anywhere in the system causes the entire logical disk to fail as it can no longer piece the media together, and the video sequence stops instantaneously and the data is lost immediately.

Video servers are often used in visitor attractions where any down time is viewed as a loss of earnings, and it is therefore seen to be critical that these servers are able to run smoothly at all times. If a logical disk fails, it not only disrupts the playback of an individual video sequence, but even after the problem is fixed, the data has to be rebuilt (from backup storage in RAID0 or with a new disk in RAID5), which can take hours (and in extreme cases, potentially days), with serious consumer satisfaction and cost implications. Current techniques to help reduce this risk are available: RAID5 or RAID10 have extra disks within the RAID setup with checksum and/or mirrored data to help manage disk failure. However, these maintain greater data redundancy and are costly in terms of extra hardware requirement for the same logical storage and time to format/build the raid drive, and with media demands continually growing, it would be desirable to find an alternative solution.

According to an aspect of the invention there is provided a video storage apparatus for providing access to a video sequence of images, the apparatus comprising:

an array of storage devices, each image in the sequence being stored on at least one of the storage devices in the array; and

a driver, the driver being operable to access the video sequence by reading images in time order from the array of storage devices, temporally adjacent ones of the images being read by the driver from different storage devices in the array.

Each image in the sequence may be stored in its entirety on at least one of the storage devices in the array. Alternatively, each image in the sequence may be spatially distributed in image portions across a plurality of the storage devices in the array, and wherein each image is accessible by reading different image portions of the image from different storage devices in the array.

By storing each image in its entirety on a particular storage device, the image can be read and displayed by accessing it from a single storage device. Although different ones of the images are on different storage devices, each individual image can be completely recovered from a single storage device. Accordingly, if a storage device within the array fails, it will only impact on those (complete) images stored on the failed device, and not any of the images stored on the other storage devices. Fast access times can be achieved by reading temporally adjacent images from different storage devices.

Each image in the sequence may be stored on only one of the storage devices in the array, on a plurality of the storage devices in the array, or on all storage devices in the array.

The driver may be operable to access the video sequence by reading images from different ones of the storage devices in a repeating order.

If the driver is unable to access an image in the sequence from a storage device, the previous image in the sequence may be displayed instead. Alternatively, the image may be obtained from a different one of the storage devices instead. In the latter case, the image is preferably obtained from a storage device from which the driver is not due to read a temporally adjacent image. Alternatively, a blended frame from the previous and subsequent frame may be generated from available stored images and displayed in real-time.

Each image may be stored as an uncompressed image file (PNG or other lossless compression file type). Alternatively, each image may be stored as a compressed file (which may be intra-coded).

Each storage device may itself comprise a plurality of physical storage devices, with each image being split across the plurality of physical storage devices. In other words, each separately addressable storage device of the present technique may comprise a RAID (redundant array of inexpensive disks) configuration of storage devices which data is striped across.

The driver may be operable to store a video sequence to the array of storage devices by alternating the storage of images to different ones of the storage devices within the array such that temporally adjacent images are stored to different storage devices.

The driver may be operable to populate a replacement storage device with images by determining its position in the array based on which of the images are to be stored in the replacement storage device. The replacement storage device may be populated automatically in response to it being detected by the driver.

Conveniently, the temporal position of each image in the video sequence may be indicated by the file name of the file storing that image. In this case, the driver may be operable to identify which of the storage devices is to be used to store a video image based on its file name. Similarly, the driver may be operable to identify from which storage devices an image is to be retrieved based on its file name.

It will be appreciated that under the above described arrangement, data may be stored to and read from each storage device independently. In other words, each storage device is an independently addressable storage device as far as an operating system is concerned. The driver enables these independently addressable storage devices to be used together to improve access to the data stored thereon.

Preferably, each image in the sequence is stored as a complete file on at least one of the storage devices in the array. However, in some embodiments, multiple images could be stored in a single file on at least one (or several, or all) of the storage devices in the array.

According to another aspect of the invention, there is provided a video storage method of providing access to a video sequence of images, the method comprising:

providing a video sequence of images on an array of storage devices, each image in the sequence being stored on at least one of the storage devices in the array; and

accessing the video sequence by reading images in time order from the array of storage devices, temporally adjacent ones of the images being read from different storage devices in the array.

According to another aspect of the invention, there is provided a video storage apparatus for storing a video sequence of images, the apparatus comprising:

an array of storage devices; and

a driver, the driver being operable to store the video sequence to the array such that each image in the sequence is stored on at least one of the storage devices in the array, the driver storing images to the array in time order, temporally adjacent ones of the images being stored by the driver to different storage devices in the array.

Each image in the sequence may be stored in its entirety on at least one of the storage devices in the array. Alternatively, each image in the sequence may be spatially distributed in image portions across a plurality of the storage devices in the array.

According to another aspect of the invention, there is provided a video storage method of storing a video sequence of images, the method comprising:

storing the images onto an array of storage devices in time order, temporally adjacent ones of the images being stored to different storage devices in the array and each image in the sequence being stored on at least one of the storage devices in the array.

According to another aspect of the invention, there is provided a video storage apparatus for providing access to a video sequence of images, the apparatus comprising:

an array of storage devices, an image in the sequence being spatially distributed across a plurality of the storage devices, each portion of the image being independently reproducible from a file on the storage device on which it is stored; and

a driver, the driver being operable to access an image of the video sequence by reading portions of the image from the array of storage devices, different portions of the image being read by the driver from different storage devices in the array.

Each image portion of an image may be stored on only one of the storage devices in the array. Alternatively, each image portion of an image may be stored on a plurality of the storage devices in the array. Alternatively, each image portion of an image may be stored on all of the storage devices in the array.

The driver may be operable to retrieve the video sequence by reading image portions from different ones of the storage devices in a repeating order. If the driver is unable to access an image portion from a storage device, the previous image in the sequence may be displayed instead. Alternatively, if the driver is unable to access an image portion from a storage device, the image portion may be obtained (if available) from a different one of the storage devices instead.

Each image portion may be stored as an uncompressed image file. Each storage device may comprise a plurality of physical storage devices, each image portion being split across the plurality of physical storage devices. Data may be stored to and read from each storage device independently. Each image portion may be stored as a complete file on at least one of the storage devices in the array.

According to another aspect of the invention, there is provided a video storage method of providing access to a video sequence of images, the method comprising:

providing a video sequence of images on an array of storage devices, an image in the sequence being spatially distributed across a plurality of the storage devices in the array, each portion of the image being independently reproducible from a file on the storage device on which it is stored; and

accessing an image of the video sequence by reading portions of the image from the array of storage devices, different portions of the image being read from different storage devices in the array.

According to another aspect of the invention, there is provided a video storage apparatus for storing a video sequence of images, the apparatus comprising:

an array of storage devices; and

a driver, the driver being operable to store the video sequence to the array such that an image in the sequence is spatially distributed across a plurality of the storage devices in the array, each portion of the image being independently reproducible from a file on the storage device on which it is stored.

According to another aspect of the invention, there is provided a video storage method of storing a video sequence of images, the method comprising:

storing the images onto an array of storage devices such that an image in the sequence is spatially distributed across a plurality of the storage devices in the array, each portion of the image being independently reproducible from a file on the storage device where it is stored.

It will be understood that the abovementioned optional features of the present technique as recited in relation to the first aspect of the invention may equally be applied to each of the other recited aspects of the invention.

It will be appreciated that embodiments of the present invention may be implemented as a software product (computer program) which configures a computer to access multiple storage devices in accordance with the present technique.

To help understanding of the invention, a specific embodiment thereof will now be described by way of example and with reference to the accompanying drawings, in which:

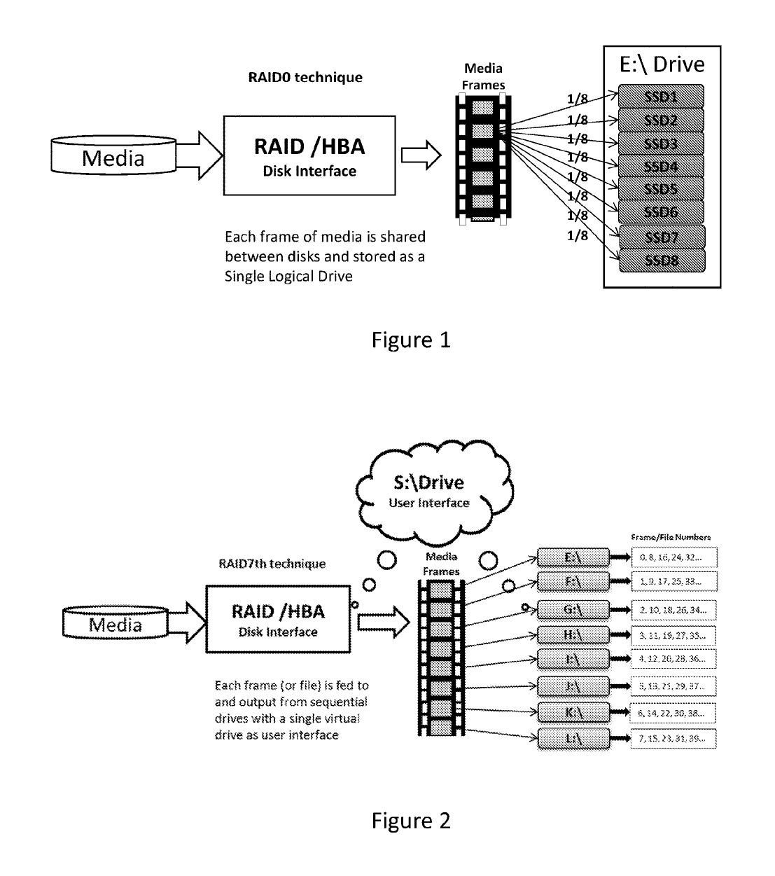

FIG. 1 schematically illustrates a conventional RAID0 server for storing video sequences;

FIG. 2 schematically illustrates a video storage apparatus according to an embodiments of the invention;

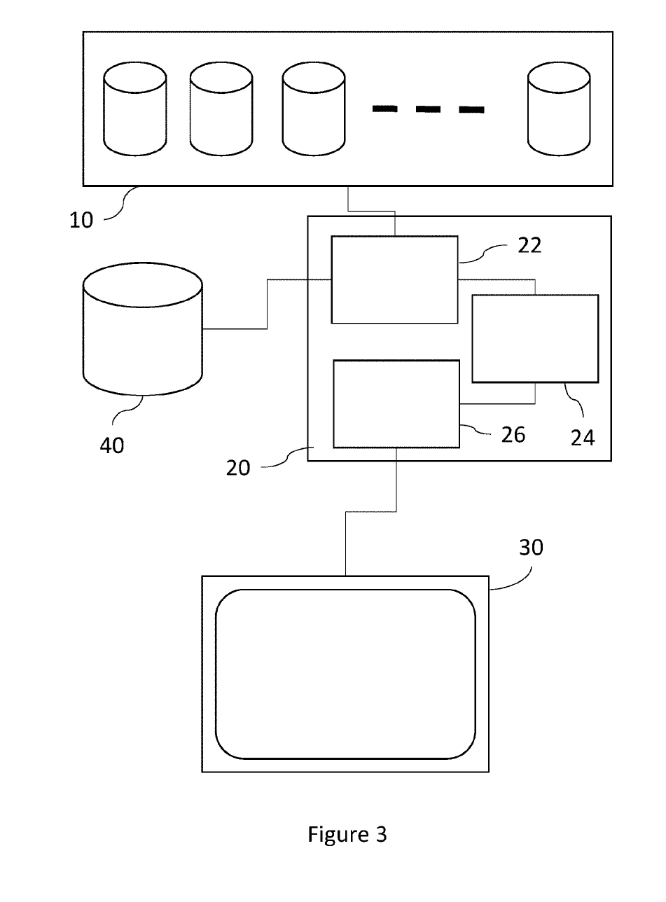

FIG. 3 schematically illustrates a video storage apparatus in more detail;

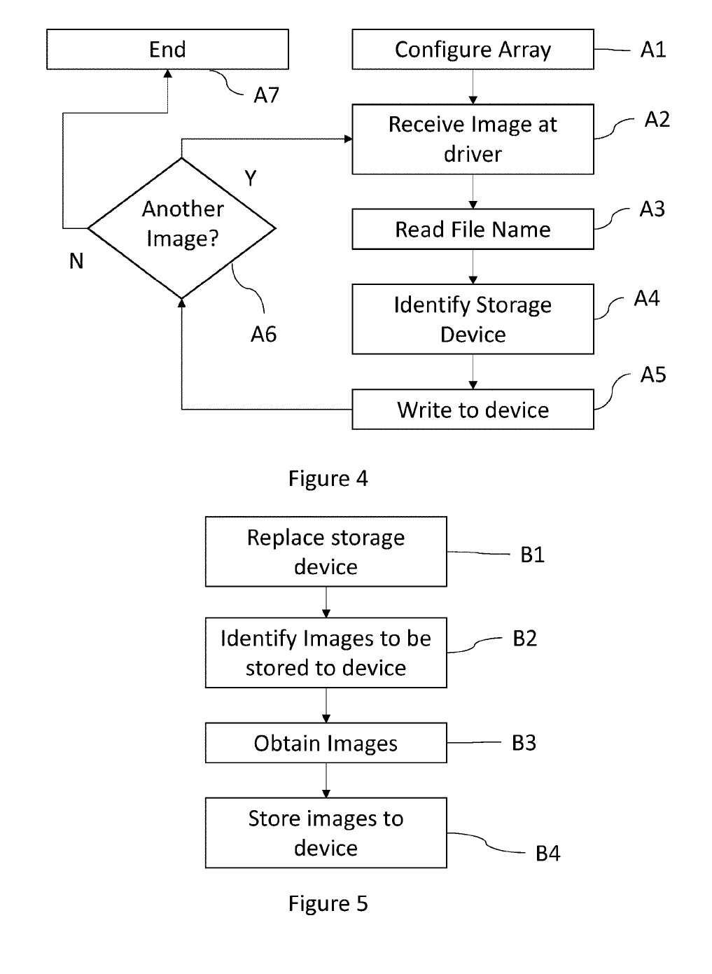

FIG. 4 is a schematic flow diagram of a process for setting up the apparatus of FIG. 3 by loading video images thereon;

FIG. 5 is a schematic flow diagram of a process for populating a replacement storage device with the required image files;

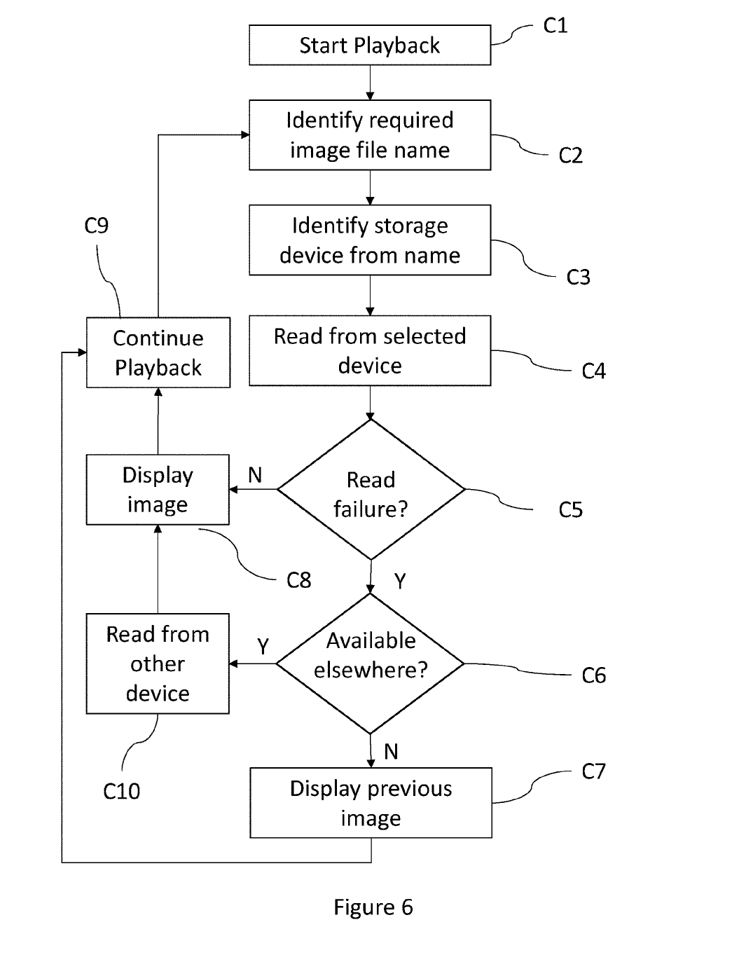

FIG. 6 is a schematic flow diagram of a playback operation, including fault handling;

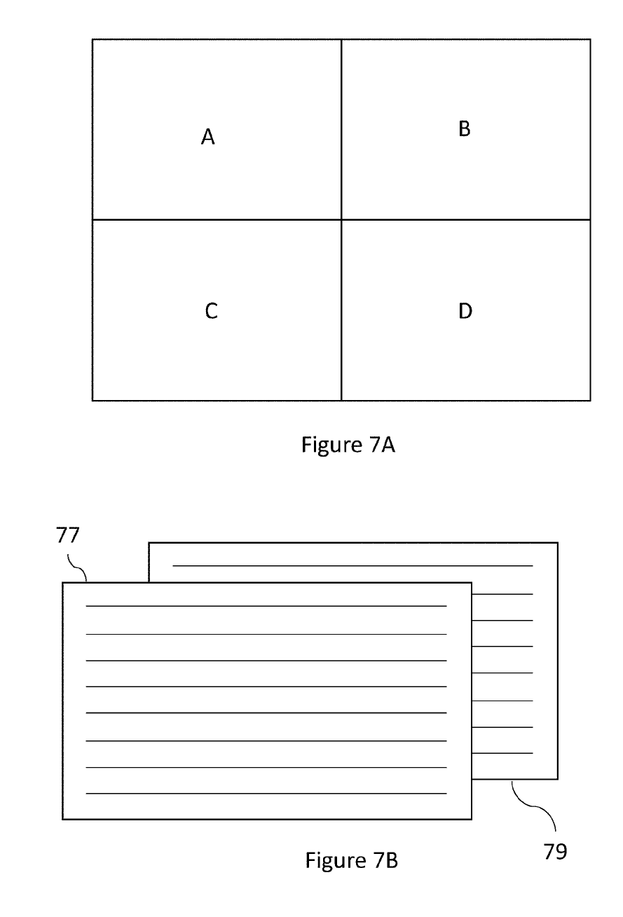

FIGS. 7A and 7B schematically illustrate how an image can be divided up into multiple image portions which can be distributed across multiple drives;

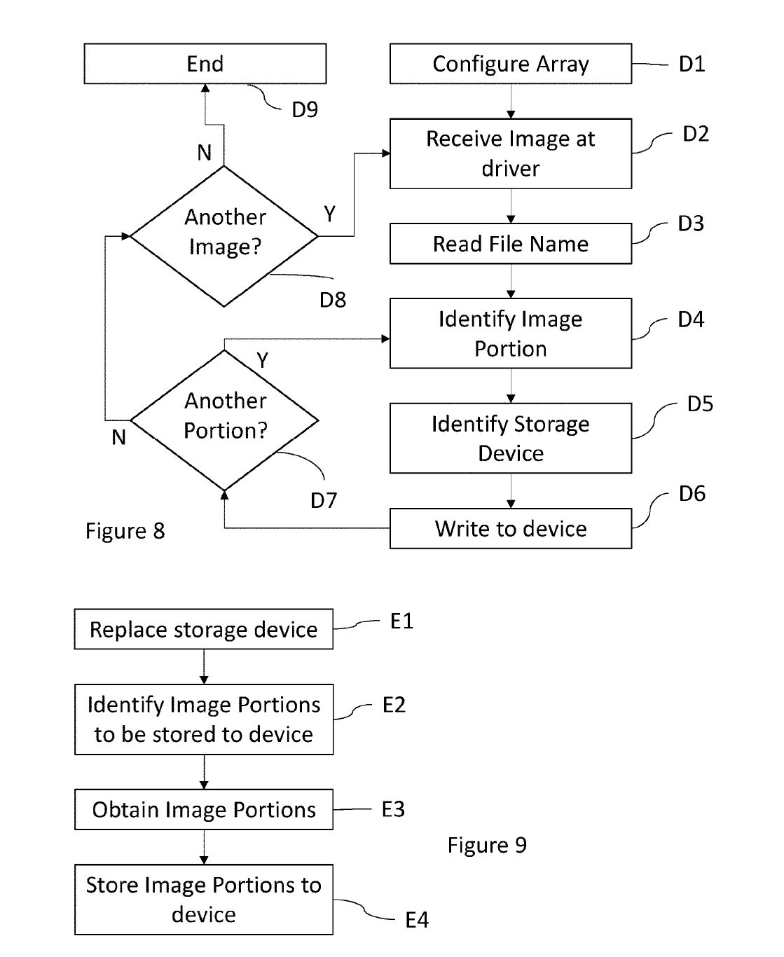

FIG. 8 is a schematic flow diagram of a process for setting up an array of disks with spatially distributed image data;

FIG. 9 is a schematic flow diagram of a process for populating a replacement storage device with the correct image portions; and

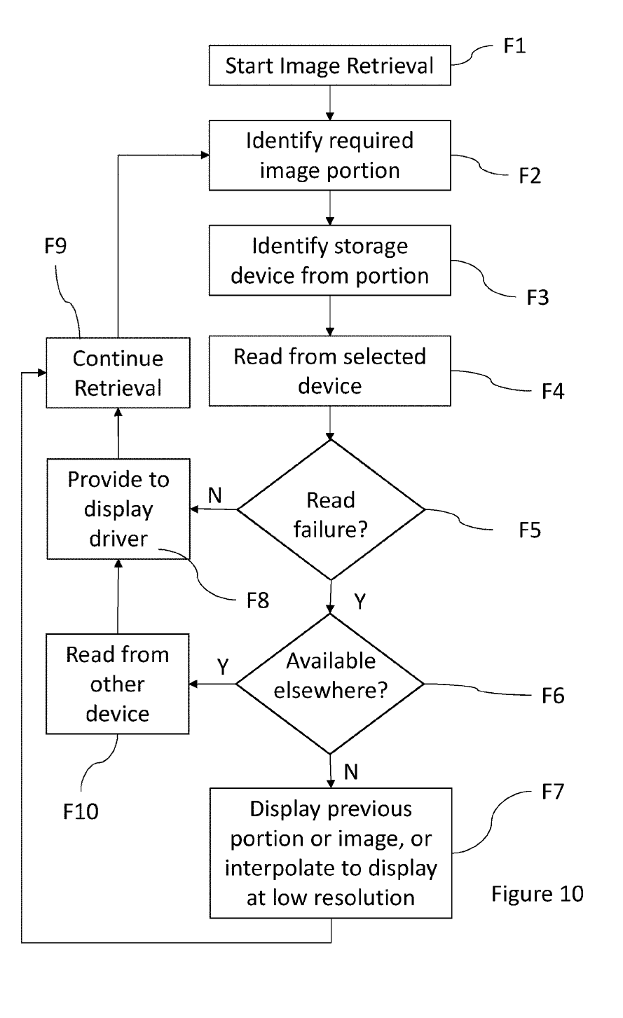

FIG. 10 is a schematic flow diagram of a process for retrieving images which have been distributed across multiple disks.

Referring to FIG. 1, the use of a conventional RAID setup as a video storage server is illustrated. As can be seen, media is transferred to an E:\ single logical drive (configurable) via a RAID0 technique, and in particular via a RAID/HBA disk interface. FIG. 1 shows that each media frame is shared between multiple disks of the RAID array—in the present case with ⅛^{th} of each media frame being stored to each of the SSD1 to SSD8. As a result, if one of SSD1 to SSD8 should fail, every single media frame will become unreadable from the logical drive as a whole because ⅛^{th} of its data will be missing.

Referring to FIG. 2, the use of the present technique to store video data in a manner which is more robust to disk failure is demonstrated. As with FIG. 1, media is transferred to a set of storage devices, but in this case by a new type of RAID-like interface which provides a virtual drive interface between a user/application and the storage devices. In contrast with FIG. 1, it can be seen that the present technique stores and accesses data from each of the storage devices individually, with each storage device being treated as a separate and independent device by the operating system. As can be seen, the storage devices are denoted as E:\ through to LA, with a virtual drive S:\ being presented via the user interface. Accordingly, as far as the user and any software applications are concerned, the array of storage devices can be treated as a single device via a driver. In particular, the individual drives are hidden from the user interface so it appears that media is still loaded into a single drive and the driver distributes the files to and from their respective residing drive without the user being aware of this.

Each image frame (or file) is fed to and output from sequential ones of the drives using a single virtual drive as a user interface. It can be seen that each of the drives may store a different subset of the data, and in particular a different subset of the image files. Specifically, drive E:\ stores frames 0, 8, 16, 24, 32 . . . , drive F:\ stores frames 1, 9, 17, 25, 33 . . . , drive G:\ stores frames 2, 10, 18, 26, 34 . . . , drive H:\ stores frames 3, 11, 19, 27, 35 . . . , I:\ stores frames 4, 12, 20, 28, 36 . . . , drive J:\ stores frames 5, 13, 21, 29, 37 . . . , K:\ stores frames 6, 14, 22, 30, 38 . . . , and drive L:\ stores frames 7, 15, 23, 31, 39 . . . . It will be appreciated from this sequencing that in order to access the image in order, the driver will need to access the drives in a repeating sequence—E, F, G, H, I, J, K, L. It will further be appreciated that the driver can initiate access to drive F (for example) before file retrieval from the drive E has been completed. In other words, multiple storage devices can be accessed substantially in parallel to greatly increase the speed with which data can be read from the storage devices compared with if the data had been stored on a single device. It will be appreciated that drive addressing need not be by letter—in a case where more than 26 drives are used, these could be addressed by name, such as “drive 1”, “drive 2”.

Referring to FIG. 3, an array 10 of storage devices is shown. The storage devices each store (or can be populated with) image files, each of which is preferably an uncompressed image file such as a bitmap (TGA) file. A computer 20 is able to access (read to and write from) the array 10 by way of a virtual storage device driver 22, which sits between an application 24 and/or user interface and presents the array 10 as a single drive. However, as mentioned previously, at an operating system level the array 10 is a set of individually addressable independent drives. If required, more or fewer disks can be configured to allow for different storage and different speed requirements. For example multiple two disk RAID0 sets maybe used to build an array of the present technique. The application 24 is not aware of which image files are stored on which of the independent drives—it merely requests a sequence of images files from the driver 22, which then handles obtaining these files from the correct one of the storage devices. The application 24 is able to retrieve a desired sequence of images files via the driver 22, and then provide the images for display on a display device 30 via a display driver 26. It will of course be appreciated that the images could be displayed on multiple display devices in parallel if required. A mass storage device 40 is also provided which stores a copy of all of the images which make up the sequence. The mass storage device 40 cannot be read fast enough to support real-time playback of the video sequence, but instead serves as a repository of data from which image files can be retrieved in non-real-time to populate or repopulate the data in the array 10. That is, the driver 22 is able to access the mass storage device 40 to obtain image files for populating the storage devices of the array 10, either during an initial setup phase (described in relation to FIG. 4 below) or during a storage device replacement phase (described in relation to FIG. 5 below).

Referring to FIG. 4, an example process for setting up the array 10 of storage devices with the correct data is explained. At a step A1, the array 10 is configured, which involves physically setting up and connecting the storage devices, establishing an operating system level connection to them (for example, establishing the devices as drives E:\ through L:\ as shown in FIG. 2), and establishing a virtual drive via the driver 22. At this point the drives are individually addressable by the operating system (and thus the driver 22), but considered as a single virtual entity by the user interface and application 24. Once this configuration is complete, the array 10 can be populated with data. In particular, at step A2, an image to be stored into the array is received from the mass storage device 40 by the driver 22. At step A3, the driver 22 reads the file name, which should indicate the position in the video sequence of the image file. For example, the image files may simply be numbered in their intended playback order (for example from 0 to 25,000). Based on the position in the sequence derived from the file name, the driver 22 identifies which of the storage devices is to be used to store this image file. For example, if the driver receives an image file number 4 in the context of FIG. 2, it can be seen that this file is intended to be written to the drive IA. More generally, temporally adjacent files are written to different storage devices in a predetermined repeating sequence. Based on the number of storage devices, the storage order and knowledge of which of the storage devices is to be used to store the first image in the sequence, it is possible to determine from a sequence position which of the storage devices is to be used to store the image file. It will however be understood that alternative ways of mapping images to storage devices could be implemented, such as the use of a mapping file which stores a correspondence between image files and drives, and which can be interrogated by the driver 22 in order to read and/or write image files from/to the array 10. At step A5, the image file is written to the identified storage device. At step A6 it is determined whether there are further images in the video sequence which need to be stored to the array 10. If further images are still to be stored, then the process returns to step A2 where the next image file is received. Otherwise, the process terminates at step A7. Once the virtual “S:\” drive software has distributed media to the disks, it can be shut down until further required or always remain visible.

Referring to FIG. 5, an example process for replacing a storage device in the array 10 (for example following failure of a storage device) is shown. At step B1, the faulty storage device is physically removed from the array and replaced with a new storage device. This is configured appropriately to be addressable (physically and virtually) in the same way as the device which it is replacing. Then, at step B2, images which are to be stored to the replacement storage device are identified. In particular, based on the number of storage devices, the storage order and knowledge of which of the storage devices is to be used to store the first image in the sequence, it is possible to determine from the position in the array of the replacement storage device which video sequence positions are to be handled by the replacement storage device, and thus which files are to be stored therein. For example, if in the context of FIG. 2 the drive H fails, then the replacement drive will need to store images 3, 11, 19, 27, 25 et seq. In particular, the result of the step B2 may be a list of sequence numbers, which map to file names of the image files as described above. At step B3, the image files identified in the step B2 are obtained by the driver 22 from the mass storage device 40, and are then stored into the replacement storage device at step B4. It will be appreciated that, similarly with FIG. 4, an alternative solution in which a mapping between image files and drives is provided using a mapping file is also possible—in which case the step B2 will involve interrogating the mapping file to identify which image files are to be stored on the replacement storage device.

It will be appreciated that if all image files are to be stored into all storage devices, then the process for both initial setup and device replacement is much simpler. If image files are to be stored to multiple ones of but not all storage devices, then the principles described above in relation to FIGS. 4 and 5 still apply, but with multiple sequences of image files being stored to each of the storage devices.

Referring to FIG. 6, a playback process is shown. At step C1, playback of a video sequence is started—for example upon initiation by the application 24, optionally under user control. This will involve the application 24 issuing a file retrieval command to the driver 22 to retrieve the first image file in the sequence. The driver 22 first identifies the file name of the required image file (the first file in the sequence for the first iteration through FIG. 6) at step C2. Then, from the identified file name (or from a mapping file, as explained in relation to FIGS. 4 and 5), the driver 22 identifies the storage device from which the image file is to be retrieved at a step C3. The driver then attempts to read the image file from the selected storage device at step C4. At step C5 the driver 22 determines if there has been a read failure in relation to the image file. If there has not been a device failure and it is possible to read the image file, then the process moves on to step C8 where the image is passed to the application 24, which then in turns passes it for display on the display device 30 via the display driver 26. Then at step C9 playback continues and the next image file required is identified at a step C2. It will be appreciated that the request for image files by the application 24 to the driver 22 may be by way of a single instruction from the application requesting the driver 22 to start sequential playback. In the context of a theme park ride the video sequence may be a repeating video sequence, and the driver 22 may simply keep cycling through the images making up the video sequence until it receives a stop command from the application 24.

If a read failure is identified at the step C5, then at step C6 it is determined if this image file is available at another of the storage devices in the array 10, and if so then it is read from the other storage device at step C10, and then displayed normally at the step C8. If however the image file is not available at another of the storage devices in the array 10, then at step C7 the previous image in the sequence is displayed instead. This could be achieved simply by providing the previous image again to the application 24, or alternatively by informing the application 24 that the requested image file is not available, whereupon the application 24 will instruct the device driver to continue to display the previous frame. The process will then progress to the step C9 where playback continues. The failure detected at the step C5 may simply be due to corrupt data on the storage device, or due to a complete device failure. In the former case the driver 22 may attempt to repair the corrupted data by replacing corrupt files on the storage device with new files from the mass storage device 40. In the latter case, the failed storage device will need to be replaced as described above in relation to FIG. 4. It will be appreciated that, in some cases the driver 22 may become aware of a storage device failure earlier than at the time of seeking to access an image file. If this is the case, at the step C4 the driver 22 will jump straight to the step C6.

It will be appreciated from the above that the driver 22 may read image files from the storage devices in a repeating order to playback a video sequence. Image files are distributed across the storage devices in a repeating order so that temporally adjacent images within the video sequence are stored to different storage devices. The repeating order in which the storage devices are accessed may match the repeating order in which the image files are stored to devices. However, if the image files are stored to multiple disks then this need not be the case—the driver could effectively pick up the ordered frames from any of the disks (which are not already being currently accessed in relation to another image file).

The present technique addresses each of the SSDs (or other storage devices such as USB) to be written to and read from, as independent drives. By recognising each of the disks as individual drives, playback can continue with any single (or potentially multiple) disk failure. The number of drives used is configurable based on the requirements of the system and multiple servers can also be used to increase capacity and playback performance, as with current methods. As with a conventional RAID configuration, an 8 disk array using the present technique will also provide an increased transfer speed of data, but media is split between disks, which are recognised independently as (for example) drives E:\ through to L:\, with the split being carried out on a discrete file basis (that is, each file is stored in its entirety on one storage device (although it may also be stored, again in its entirety, on other storage devices in the array)).

The present technique distributes whole frames/files across an array of individual disks/drives as ‘temporal data’, playing them back sequentially for the same quality visual effect. A drive may store the entire collection of files if the media is small enough to fit, or the files may be written sequentially by individual filename (frame) across the disks for larger media coverage. In either case, the files/frames will be read back sequentially from each of the drives. If the entire collection of files are stored on each of the storage devices, or if multiple copies of each file are distributed across the array (for example each file is stored on two different storage devices), then retrieval of each image file need not necessarily come from a predetermined one of the storage device. Instead, the driver may simply access the file from any one of the storage devices which is currently free to immediately process a read access instruction from the driver.

A significant benefit of the present technique is that if one disk fails the system continues reading the media and can simply ignore the failed disk, which can then be swapped at a convenient time. Instead of the intended image, the previously displayed image in the video sequence can be displayed again (or continue to be displayed). The technique utilises the human ocular ability to overlook (in most cases) minimal frame drops when running at very fast rates. In the example of a server using 8 disks, 1 in 8 frames will be dropped but at a speed of 60 frames per second, the dropped frames are almost unrecognizable to the untrained eye and so cause minimal visual disruption. In the alternative, if the entire media is stored on each of the storage devices in the array (or at least on multiple of the storage devices within the array), given that each disk is generally not running to full capacity, when one disk fails another can be prompted to read back the missing data for continued, smooth playback. It will be appreciated that the backup storage device in this case should be one which is relatively distant in the access order from the faulty storage device in order not to stall retrieval of other image files. For example, if (referring to FIG. 2) drive G fails, then retrieving the missing image file from drives H or I may conflict with access to the next image file, while retrieving the missing image file from drives E or F may not be possible if previous image files have not yet been fully read. However, drive K may be sufficiently distant in the drive access order that it has time both to act as a backup for drive G (therefore reading images 2, 10, 18, 26, 34 . . . ) and also to read back the files it is dedicated to handle (images 6, 14, 22, 30, 38). Put another way, with this example there is a 3 frame gap between each image file to be retrieved using the drive K.

In either case, the failed disk can be easily removed and replaced (during or after video playback) with no further disruption: media is easily restored (remotely from the master source or on-site via USB or other) to the virtual “S:\ drive”, which re-distributes the missing data to the new disk(s). This is a faster and more robust process than the current RAID approach as only data for the individual disk(s) needs to be restored. The process, and in particular the auto-population of image files to the replacement disk, may also be automated based on the system detecting a new disk being present.

The present technique only requires enough disks to meet the bandwidth requirements (but more can be added if required) since if one fails, the consequences are relatively unnoticeable. In contrast, current RAID configurations would require extra disks, at extra cost, to immediately cater for disk failure. Furthermore, the technique reduces data redundancy compared with an equivalent RAID configuration, since it is not necessary to provide extra disks with checksum or mirrored data stored within a standard setup. The user experience can be expected to be generally equal to current RAID techniques, but is vastly beneficial in the event of a disk failure. Disks can be swapped in and out with minimal disruption to a show for continued ocular viewing and lower maintenance disruption/cost for the media director. It will be understood that the present technique can utilise any storage media, not just SSDs, and has the capacity to write to as many as required for the media solution (for example 20 USB storage devices).

Various modifications to the above-described embodiments can be envisaged. For example, rather than obtaining a missing image from another disk, or skipping the missing image entirely, a replacement image can be synthesised from other images. For example, given an image sequence a, b, c, if the image b is found to be missing due to a disk error, a replacement image b′ may be generated by interpolating or averaging between the images a (the previous image in the sequence) and c (the next image in the sequence). Suitable techniques may be similar to those used for motion compensation in MPEG video encoding. Provided that these techniques can be performed in real time, the generated images can be inserted in the place of the missing images.

It will be understood that the present technique also makes it possible to write data to storage media at a higher rate, since the driver can write data in parallel to multiple storage devices within the array. Further, if one (or more) of the storage devices in the array should fail, the driver can continue to write data to the operational storage devices in the array, resulting in a usable (albeit incomplete) stored video sequence. The non-operational storage device can later be replaced and populated with the missing images in the sequence in the manner described above.

While the above embodiments stored complete images to different storage devices within the array, it will be appreciated that another potential way of distributing the video sequence across multiple devices could be to spatially separate image data from each image across two or more devices. For example, even numbered lines of pixels of a particular image could be stored on one storage device, and odd lines of pixels of the same image could be stored on another storage device. In this way if a storage device fails then the system can continue with half resolution media, or alternatively the missing lines could be interpolated from the available lines. It will be appreciated that the same principle could be applied across more than two storage devices, with a repeating pattern of n lines within the image being written to n different storage devices in an array. It will be understood that the lines need not be horizontal lines, but could be vertical lines of pixels. It should also be understood that other spatial separation could be used—for example blocks of pixels rather than lines. More generally, different spatial portions of each image can be written to different ones of the storage devices in the array, in a manner in which permits those portions to be independently reproduced from their respective storage devices and used to form an image for display, even if other portions of the image are not available. In other words, even though this variant splits images across multiple storage devices, the separate portions of the image are still stored as independently reproducible image files, which can be combined by the driver into an image for display.

Generally, the explanations given above of an implementation in which images are temporally distributed across disks applies also to an implementation in which spatial portions of images are distributed across disks. An example of such a spatially distributed storage and retrieval method is described with reference to FIGS. 7 to 10, in order that the differences between the two implementations can be better understood. In FIG. 7A, an image area is shown to be split into four spatial portions A, B, C and D. In the present embodiment, each of these portions is to be stored to a different storage device. In FIG. 7B, an image area is shown to be split into two spatial portions—a first portion consisting of odd rows of pixels of the image and a second portion consisting of even rows of pixels of the image. It will be appreciated that other implementations—such as alternating or sequences of columns of pixels, or alternating or sequences of pixels—can be used instead. The odd rows and even rows respectively could be two fields of an image frame. In either the example of FIG. 7A, or the example of FIG. 7B, the image portions may be stored as uncompressed image files.

Considering the 8 drive array of FIG. 2 in light of the spatial distribution implementation, as with the temporally distributed embodiment described above, each of the drives may store a different subset of the data, but in the present embodiment the subsets will be different spatial portions of the image files in a sequence of images rather than (or in addition to) different images within the sequence. It will be understood that it is possible for the images to be both spatially and temporally distributed across the drives. For example, in the case of FIG. 7A each image is divided into four rectangular regions, each of which is stored to and accessible from a different one of the drives E to L. However, given that there 8 drives and only 4 spatial regions, it is possible to spread two image frames, each comprising 4 spatial regions, over the 8 drives. For example, if the regions of all odd numbered frame in a sequence are denoted oA, oB, oC and oD and the regions of all even numbered frame are denoted eA, eB, eC, eD, the drive E:\ may store regions oA, drive F:\ may store regions oB, drive G:\ may store region oC, drive H:\ may store regions oD, drive I:\ may store regions eA, drive J:\ may store regions eB, drive K:\ may store regions eC and drive L:\ may store regions eD.

It will be appreciated that the driver can initiate access to drives E, F, G and H substantially concurrently. This enables the entire image, that is the 4 spatial regions A, B, C and D of that image, to be retrieved much more quickly than would be possible if the image as a whole was retrieved from a single drive. This benefit may be utilised to make real-time retrieval and display of high resolution and/or high frame rate image sequences possible, where an image frame could otherwise not be retrieved within a single-frame period. While in the present example the number of drives is greater than the number of image portions (thus permitting both spatial and temporal distribution of images across drives), it will be appreciated that in alternative embodiments the number of image portions may be the same as (or greater than) the number of drives, in which case retrieving a given image may require access to all drives. In the case of FIG. 7B, by splitting each image into two portions (one portion being the odd lines and the other portion being the even lines), 4 images of a sequence can be temporally and spatially distributed over 8 drives. That is, the drives E and F may respectively store the two portions of a first image, drives G and H may respectively store the two portions of a second image, the drives I and J may respectively store the two portions of a third image and the drive K and L may respectively store the two portions of a fourth image.

It will be understood that the system description of FIG. 3 is equally applicable to both the temporal distribution and the spatial distribution of image data. The differences reside in how image data is handled by that system, as described below with reference to FIGS. 8 to 10.

Referring to FIG. 8, an example process for setting up an array of storage devices with the correct data, with images spatially distributed across the storage devices, is explained. At a step D1, the array is configured in the same manner as described in the step A1 of FIG. 4. Once this configuration is complete, at step D2, an image to be stored into the array is received from the mass storage device 40 by the driver 22. At step D3, the driver 22 reads the file name, which should indicate the position in the video sequence of the image file. For example, the image files may simply be numbered in their intended playback order (for example from 0 to 25,000). At a step D4, the driver 22 identifies a portion of the image to be stored (for example one of the portions A, B, C or D described in FIG. 7A). Based on the position in the sequence derived from the file name and the portion to be stored, the driver 22 identifies at a step D5 which of the storage devices is to be used to store this image portion. Generally, different spatial image portions are written to different storage devices in a predetermined repeating sequence (for example A, B, C D). The sequence need not be the same for each frame. For example, in some embodiments the repeating pattern may repeat over 4 frames, with the four portions of the first frame being stored in sequence A, B, C, D, the four portions of the second frame being stored in sequence D, B, A, C, the four portions of the third frame being stored in sequence B, D, C, A and the four portions of the fourth frame being stored in sequence D, C, B, A. An advantage of this arrangement is that if a particular drive fails, different portions of each image are lost, rather than the same portion of all images.

At step D6, the image portion is written to the identified storage device. At step D7 it is determined whether there are further portions of the same image which need to be stored to the array 10. If so, the process returns to the step D4 where the next portion of the image is processed. If it is determined at the step D7 that there are no further portions of that image to be stored, then at a step D8 it is determined whether there are further images in the video sequence which need to be stored to the array 10. If further images are still to be stored, then the process returns to step D2 where the next image file is received. Otherwise, the process terminates at step D9.

Referring to FIG. 9, an example process for replacing a storage device in the array 10 (for example following failure of a storage device) is shown, again for the example where image data is spatially distributed across the array 10. At step E1, the faulty storage device is physically removed from the array and replaced with a new storage device. Then, at step E2, image portions which are to be stored to the replacement storage device are identified. For example, if in the context of FIG. 7A the drive H fails, then the replacement drive may need to store image portions oD (that is, the spatial region D of odd numbered image frames), or may store different portions of different frames in accordance with a particular multi-frame repeating sequence. In particular, the result of the step E2 may be a sequence of image frame numbers and spatial areas. At step E3, the image portions identified in the step E2 are obtained by the driver 22 from the mass storage device 40, and are then stored into the replacement storage device at step E4.

Referring to FIG. 10, an image retrieval process is shown. For simplicity, FIG. 10 relates to the retrieval of a single image from an image sequence. It will therefore be appreciated that the process of FIG. 10 may be repeated for each image in a sequence. At step F1, retrieval of an image is started with the application 24 issuing a file retrieval command to the driver 22 to retrieve the image file. The driver 22 first identifies the required image portion (the first portion of the image for the first iteration through FIG. 10) at step F2. Then, the driver 22 identifies the storage device from which the image portion is to be retrieved at a step F3 based on (for example) a predetermined mapping between image portions and drives (which mirrors the storage sequences described in relation to FIG. 8). The driver 22 then attempts to read the image portion from the selected storage device at step F4. At step F5 the driver 22 determines if there has been a read failure in relation to the image portion. If there has not been a device failure and it is possible to read the image portion, then the process moves on to step F8 where the image portion is passed to the application 24, which then in turns passes it for display on the display device 30 via the display driver 26. It will be appreciated that the display driver 26 (or the application 24) may not start to display the image until all image portions have been received. At a step F9 retrieval continues and the next image portion required is identified at the step F2.

If a read failure is identified at the step F5, then at step F6 it is determined if this image portion is available at another of the storage devices in the array 10, and if so then it is read from the other storage device at step F10, and passed to the display driver at the step F8. If however the image file is not available at another of the storage devices in the array 10, then at step F7 an action is taken to minimise the visual disruption to the viewer. Such actions may include displaying the same portion from a previous image in the sequence, rejecting all portions of the present image in the sequence and instead continuing to displaying the previous image in the sequence, interpolating missing image portions based on retrieved image portions (this would not work in the FIG. 7A example, but could work where the image portions are smaller regions—for example the alternate lines of FIG. 7B) to effectively display the image at a lower effective resolution. The process may (depending on the action taken at the step F7) then progress to the step F9 where retrieval continues.

1. A video storage apparatus for providing access to a video sequence of images, the apparatus comprising:
an array of storage devices, each image in the sequence being stored on at least one of the storage devices in the array; and
a driver, the driver being operable to access the video sequence by reading images in time order from the array of storage devices, temporally adjacent ones of the images being read by the driver from different storage devices in the array.

2. A video storage apparatus according to claim 1, wherein each image in the sequence is stored in its entirety on at least one of the storage devices in the array.

3. A video storage apparatus according to claim 1, wherein each image in the sequence is spatially distributed in image portions across a plurality of the storage devices in the array, and wherein each image is accessible by reading different image portions of the image from different storage devices in the array.

4. A video storage apparatus according to claim 1, wherein each image in the sequence is stored on only one of the storage devices in the array.

5. A video storage apparatus according to claim 1, wherein each image in the sequence is stored on a plurality of the storage devices in the array.

6. A video storage apparatus according to claim 1, wherein each image in the sequence is stored on all of the storage devices in the array.

7. A video storage apparatus according to claim 1, wherein the driver is operable to access the video sequence by reading images from different ones of the storage devices in a repeating order.

8. A video storage apparatus according to claim 1, wherein if the driver is unable to access an image in the sequence from a storage device, the previous image in the sequence is displayed instead.

9. A video storage apparatus according to claim 1, wherein if the driver is unable to access an image in the sequence from a storage device, the image is obtained from a different one of the storage devices instead.

10. A video storage apparatus according to claim 1, wherein if the driver is unable to access an image in the sequence from a storage device, a blended image is generated from available stored images and displayed in real-time.

11. A video storage apparatus according to claim 9, wherein the image is obtained from a storage device from which the driver is not due to read a temporally adjacent image.

12. A video storage apparatus according to claim 1, wherein each image is stored as an uncompressed image file.

13. A video storage apparatus according to claim 1, wherein each storage device comprises a plurality of physical storage devices, each image being split across the plurality of physical storage devices.

14. A video storage apparatus according to claim 1, wherein the driver is operable to store a video sequence to the array of storage devices by alternating the storage of images to different ones of the storage devices within the array such that temporally adjacent images are stored to different storage devices.

15. A video storage apparatus according to claim 1, wherein the driver is operable to populate a replacement storage device with images by determining its position in the array based on which of the images are to be stored in the replacement storage device.

16. A video storage apparatus according to claim 15, wherein the replacement storage device is populated automatically in response to it being detected by the driver.

17. A video storage apparatus according to claim 1, wherein the temporal position of each image in the video sequence is indicated by the file name of the file storing that image.

18. A video storage apparatus according to claim 17, wherein the driver is operable to identify which of the storage devices is to be used to store a video image based on its file name.

19. A video storage apparatus according to claim 17, wherein the driver is operable to identify from which storage devices an image is to be retrieved based on its file name.

20-21. (canceled)

22. A video storage method of providing access to a video sequence of images, the method comprising:
providing a video sequence of images on an array of storage devices, each image in the sequence being stored on at least one of the storage devices in the array; and
accessing the video sequence by reading images in time order from the array of storage devices, temporally adjacent ones of the images being read from different storage devices in the array.

23-41. (canceled)
